(19) United States
(12) Patent Application Publication
(10) Pub. No.: US 2020/0324830 A1
(43) Pub. Date: Oct. 15, 2020

(54) METHOD OF MAKING A FLAT BUILDING COMPONENT

(71) Applicant: Maximilian PRINZ, Passau (DE)

(72) Inventor: Maximilian PRINZ, Passau (DE)

(21) Appl. No.: 16/790,786

(22) Filed: Feb. 14, 2020

(30) Foreign Application Priority Data
Apr. 12, 2019 (DE) 102019109823.8

(51) Int. Cl. B62D 29/04; B29C 44/08; B29C 44/12; B29C 44/14; B29C 44/44; B29C 44/56

(52) U.S. Cl. CPC B62D 29/043; B29C 44/083; B29C 44/1266; B29C 2035/0822; B29C 44/14; B29C 44/445; B29C 44/5681; B29C 44/1285

(57) ABSTRACT

The invention relates inter alia to a method of making a thin component (10) in lightweight sandwich construction with a high-quality surface (26).

The invention relates to a method of making a thin component in lightweight sandwich construction with a high-quality surface.

Such methods have been developed by the applicant for decades and carried out on a large scale.

Reference is made purely by way of example to the following German patent applications of the applicant:

DE 10 2018 117 337, DE 10 2017 109 953, DE 10 2016 112 290 A1, DE 10 2013 018 694 A1, DE 10 2013 008 592 A1, DE 10 2013 005 523 A1, DE 10 2013 008 364 A1, DE 10 2015 111 052 A1 and DE 10 2012 017 698 A1,

the content of which is hereby included in the content of the present patent application to avoid repetition.

The applicant is also holder of the German post-published patent application DE 10 2018 123 703 A1 [US 2020/0094449] that describes a method of making a component in which granular loose particles of an expandable particle foam are initially partially expanded, then introduced in particular into a lower mold part, and are finish-expanded in the mold.

The methods mainly applied by the applicant hitherto of making such a thin component comprise in particular compounds of thermoplastic thermoformed films with polyurethane foam masses.

Starting out from this, the object of the invention is to specify a method with which a thin component can be manufactured that meets the requirements for low weight and high stiffness and can be manufactured inexpensively.

The invention achieves this object with the features of claim 1.

The principle of the invention consists initially in using an expandable particle foam instead of the polyurethane two-component foams used hitherto.

Particle foams of EPS, EPE and EPP, for example, are possible as suitable expandable particle foams. These are particle foams that can have densities in the range of typically 15 kg/m³ to 80 kg/m³ in the fully or finally expanded and cured state.

According to the invention, a film-like substrate is first provided. This can be a thermoformable film, for example, e.g. of ABS or PMMA. This can have a wall thickness, for example, of between 0.2 mm and 13 mm. The film can be thermoformed in a first mold, for example. The substrate used can also be provided, however, by a thin skin, a thin film, e.g. of metal, or another planar material. The substrate does not have to be thermoformed.

According to the invention the substrate is arranged in a lower mold part. The lower mold part has in particular a receiving space for particles here that will be explained in greater detail later.

The method according to the invention now provides that granular starting material is provided in the form of loose particles of an expandable particle foam. Such materials, which are known as expandable particle foams, are therefore possible. In particular, expandable particle foams of EPS, EPE or EPP, or also expandable PEEK are understood by this. Another definition is given below.

The granular starting material can be provided in the form used of small balls or pearls, or in the form of granular particles of another regular or also irregular shape and geometry. The starting material is pourable in particular.

The particles are present loosely in the granular starting material, i.e. in particular not firmly joined to one another.

The step of complete expanding of the particles now takes place according to the invention. Complete expanding means that the particles, on attaining their completely expanded state, cannot be expanded further. For example, the expandable or foamable granular particles of the particle foam can have blowing agents that ensure the expanding process. A completely expanded particle has no further blowing agent. When the particle is completely expanded, this has completely escaped from the particle.

According to the invention, the completely expanded particles are still loose, however, meaning that they are not firmly joined to one another, and are in particular pourable. They can be small balls, for example, or bodies of any other spatial form.

The expanded particles existing as granulate can be baked with one another in the mold in a step described below, and in this case baked at the same time with the substrate. Such a process can also be termed sintering.

During the step of baking—unlike in the post-published German patent application DE 10 2018 123 703.0 referred to above—no volume increase takes place, or at most only a slight volume increase takes place.

It is also comprised by the invention when the volume of the particle foam mass is reduced during the step of baking. This can be achieved, for example, by overcharging the mold with completely expanded particles.

In this variant the volume of the completely expanded particles provided is therefore greater than the cavity in the mold. On closing of the mold, the volume of the expanded particles is reduced for the purpose of baking and to achieve a homogeneous particle foam mass.

In one variant of the invention, pressure is additionally exerted on the particle foam mass in the course of closing the mold to achieve a homogeneous particle foam mass.

For example, it can be provided according to the invention that related to an expanding or expansion process from 0 to 100% starting out from the volume of the particles of the starting material to the volume of the particles in the finally expanded state, complete expanding takes place between 95% and 100%.

The step of complete expanding of the particles takes place in particular—but not mandatorily—at a point that is located remotely from the lower mold part in which the substrate is arranged. More advantageously the complete expanding of the particles can be carried out in an oven, in particular in an infrared baking oven.

According to another step of the process according to the invention, it can be provided that the completely expanded particles are introduced into the lower mold part. The transport of the completely expanded particles can be carried out, for example, timewise directly after carrying out the step of complete expanding of the particles. It can also be carried out much later in time, however, after carrying out the step of complete expanding of the particles.

An introduction and/or arrangement or positioning of the completely expanded particles in the lower mold part can take place mechanically, automatically or manually.

According to the invention, the multipart, in particular at least two-part mold, comprising an upper and a lower mold part, is then in particular closed. To this end an upper mold part, for example, can be moved towards the lower mold part and a receiving space or cavity for the completely expanded particles—as well as for the substrate located in the lower mold part—can be sealed.

Furthermore, the mold is heated according to the invention. It is also comprised by the invention when the mold is maintained continuously at a constant temperature or at a temperature within a predetermined temperature range. It is also comprised by the invention, furthermore, when the mold is subjected to thermal cycling in order to be able to provide high temperatures above the melting temperature of the particle foam and temperatures below the melting temperature of the particle foam as part of a cycle.

A step then takes place according to the invention of baking the completely expanded particles to a homogeneous or substantially homogeneous curable particle foam mass. The particles bake or sinter to one another, so to speak. Here the particle foam mass is bonded at the same time to the substrate. The activation of the step of baking is achieved via the mold temperature.

The particle foam mass is then left to cure according to the invention. In consequence of this curing process, the particle foam mass forms a durable firm bond with the substrate.

It is also comprised by the invention when the substrate is provided on its inner face directed toward the particle foam mass with a suitable chemical, e.g. an adhesive primer, before the introduction of the expanded particles into the lower mold part, in order to optimize the bond between the substrate and the particle foam mass and formation of the bond between the substrate and the particle foam mass.

After letting the particle foam mass cure, the mold can be opened, and the molded body thus formed can be removed. The molded body thus formed represents the component to be made according to the invention, or can develop into such a component by subsequent processing steps.

Definition of Expandable Particle Foam:

In the context of the present patent application, the following materials, for example, are regarded as expandable particle foams:

Expandable polystyrene is described by the acronym EPS. This is known, for example, under the brand designation Styropor and can be obtained e.g. from the company Metz EPS-Hartschaumzuschnitte in 74376 Gemmrigheim.

Expandable polyethylenes (EPE) are also regarded as particle foam in the context of the present patent application. Finally, expandable polypropylenes (EPP) are also regarded as well suited to the purposes according to the invention.

Thermoplastic particle foams are comprised in particular by the term particle foam in the sense of the present patent application. As a granulate, in particular also micro granulate starting material, for example with diameters of the particles in the order of between 0.1 mm and 5 mm, these can further preferably have particles with a diameter of approx. 1 mm.

Blowing agents are preferably arranged in the granular starting material particles of the particle foam. These can be activated thermally and/or by chemicals, for example also by the influence of steam, in order to activate the expanding process.

Pentane, for example that is polymerized into the granular particles, may be considered as a blowing agent for polystyrene particle foam particles. As soon as the particles are exposed to temperatures of over 100° C., the blowing agent can vaporize and in doing so inflates the thermoplastic base material into polystyrene foam particles.

Baking or sintering can take place according to the invention only in the lower mold part, wherein the mold temperature is selected so that the particles can form a curable bond with one another and with the substrate.

As well as EPS (extrudable polystyrene), XPS may also be considered for the invention.

The company Schaumaplast GmbH & Co. KG in 68799 Reilingen may be considered as a supply source for expandable polypropylene EPP and XPS.

Particle foams for use with the invention can also be provided by expandable copolymers. Such materials can be obtained under the trade name Grupor, for example, from Kunststoffwerk Katzbach GmbH & Co. KG in 93413 Cham.

Expandable PEEK (polyether ether ketone) may also be considered as a starting material of the particle foam usable in the context of the invention. This is obtainable under the trade names Gatone or Victrex, for example.

The method according to the invention is used to produce a component with a high-quality surface. A high-quality surface can be formed to be particularly durable, for example, e.g. to be impact-resistant to a particular extent, and can also be suitable in particular for external applications. In particular, a high-quality surface can have properties such as are required in so-called Class A surfaces.

The invention relates to a method of making a thin component. The term thin means that the component extends along a surface in an x- and y-direction considerably further than in a z-direction perpendicular to this. The surface can be formed level or curved in space, also multiply curved, and assume any spatial form.

According to an advantageous configuration of the invention, the substrate is provided by a thermoformed film. This permits recourse to conventional constituents of a component that are already extensively proven and facilitate to a particular extent the provision of a high-quality surface for the component.

According to another advantageous configuration of the invention, the performance of step k) is provided: application of a cover layer to the face of the particle foam mass directed away from the substrate. Such a cover layer can be, for example, an interior décor layer, for example a wall paneling, in particular a plastic coating. In the case that the fabricated component forms e.g. a wall or a wall section of a caravan or a caravan trailer, the décor layer can be e.g. a typical interior design surface of such a caravan in a conventional manner.

According to another advantageous configuration of the invention, the method according to the invention comprises the following step:

1) processing of the molded body into a component.

Various processing methods may be considered as processing steps. These include, for example, separation or detachment of parts or regions of the molded body, if applicable even detachment or separation of sections of the substrate. These include e.g. also a step of cleaning, and/or a step of surface treatment, in particular on the outside of the substrate, for example roughening or polishing or smoothing of the surface, if applicable also the application of an additional layer or film, for example an additional functional layer.

It is also comprised by the invention when the face of the cured particle foam mass directed away from the substrate is processed, for example connected to an additional skin or an additional material or a film, or acted upon, e.g. sprayed, laminated, lacquered, riveted, screwed or bonded to another element.

According to another advantageous configuration of the invention, the film has a wall thickness of between 0.2 mm and 13 mm. This embodiment of the invention likewise permits recourse to conventional films that have been proven in countless composites and whose thermoforming properties and surface attributes are sufficiently known and researched.

According to another advantageous configuration of the invention, the cured particle foam mass comprises a wall thickness between 1 cm and 30 cm. The wall thickness of the cured particle foam mass is calculated and designed as a function of the required strengths of the manufactured component. In spite of the relatively great wall thicknesses, the finished component can weigh very little.

According to another advantageous configuration of the invention, the component is designed as a vehicle part for a motor vehicle, or for a commercial vehicle, or for a trailer, and is for example an interior design part, or a cargo space cover, or a lining part, or an engine bonnet, or a roof element, or a roof segment, or a vehicle wall, or a vehicle wall element.

According to another advantageous configuration of the invention, the granular starting material comprises expandable EPS, expandable EPP or expandable PEEK. These are all materials that are foamable, i.e. expandable, and that are suitable according to the invention to be completely expanded or expanded, in order subsequently to be able to be supplied loose, in the form of granulate, to a mold and to be able to be baked in the mold.

According to another advantageous configuration of the invention, the method comprises the step m) that is carried out before step h):

m) positioning of reinforcing elements, in particular tension anchors, for example tapes, in the lower mold part, wherein following the introduction of the partially expanded particles into the lower mold part, the particles encase the reinforcing elements.

According to this advantageous configuration of the invention, the expanded particle foam mass is reinforced or stiffened by reinforcing elements. These are designed in particular so that they can transmit tensile forces in a direction transverse to the planar extension of the component. The stiffness of the component can be increased by this. It is also comprised by the invention when the reinforcing elements extend along the extension direction of the thin component. In this case, for example even planar constructs such as mats, webs, mesh etc. of reinforcing fibers, for example of glass fibers, carbon fibers, aramid fibers, basalt fibers or other suitable reinforcing fibers can be laid into the lower mold part before filling the cavity with partially expanded particles.

According to another aspect, the invention relates to a thin component according to claim 10.

The object of the invention is to specify a component that has a high strength and bearing capacity with only little weight, and that can be made inexpensively.

The invention achieves this object with the features of claim 10.

To avoid repetition, with regard to the clarification and explanation of the features of claim 10 and the explanation of the invention according to claim 10, reference is made to the previous implementations for claims 1 to 9 by analogy.

Other advantages of the invention result from the subordinate claims, which are not cited, and by means of the following description of the embodiments depicted in the drawings.

Therein:

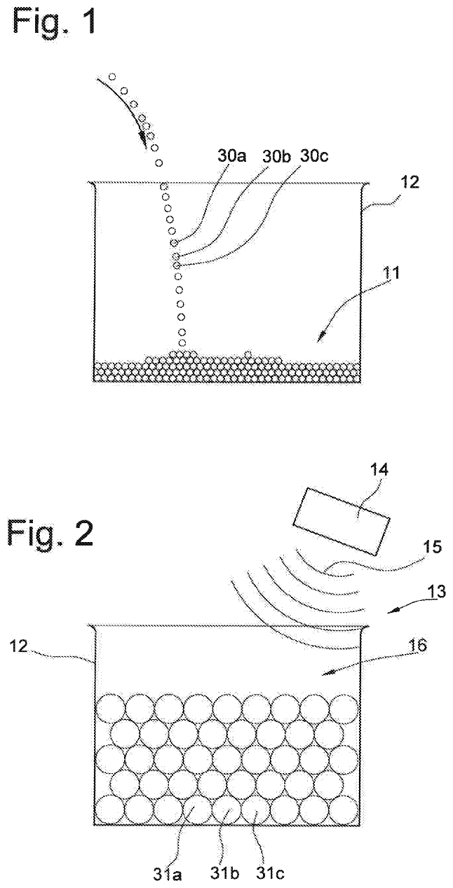

FIG. 1 shows, in a partially sectional, schematic view, an embodiment of an oven, into which granular starting material in the form of particles of a particle foam is filled, wherein the granular starting material is unexpanded,

FIG. 2 shows the oven in FIG. 1 with additionally depicted infrared radiation heating, wherein the particles previously poured in are transferred to a completely expanded state,

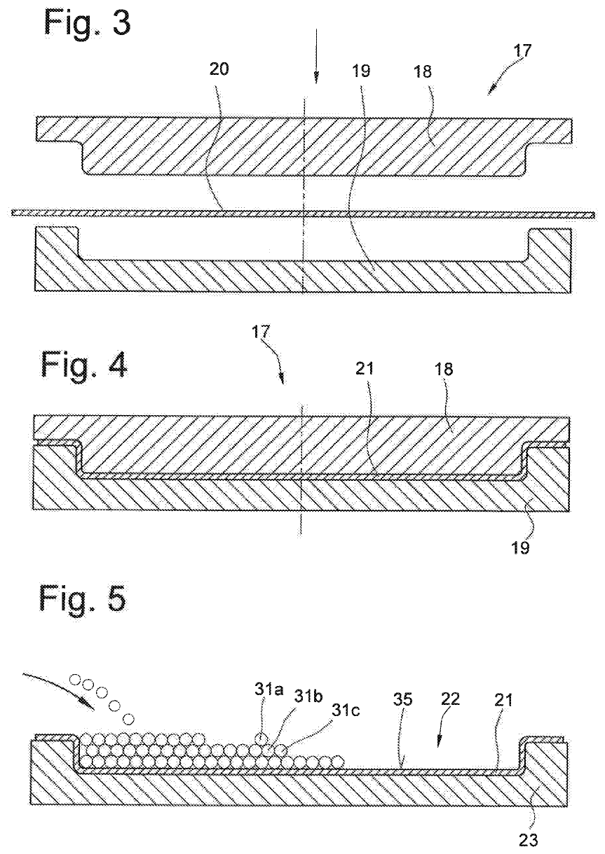

FIG. 3 shows a first mold with lower mold part and upper mold part and a film in a web-shaped, flat state designed as a substrate,

FIG. 4 shows the closed mold in FIG. 3 with thermoformed film,

FIG. 5 shows another mold, in which the thermoformed film of FIG. 4 is positioned, wherein the completely expanded particles of the particle foam according to FIG. 2 are filled into the lower mold part,

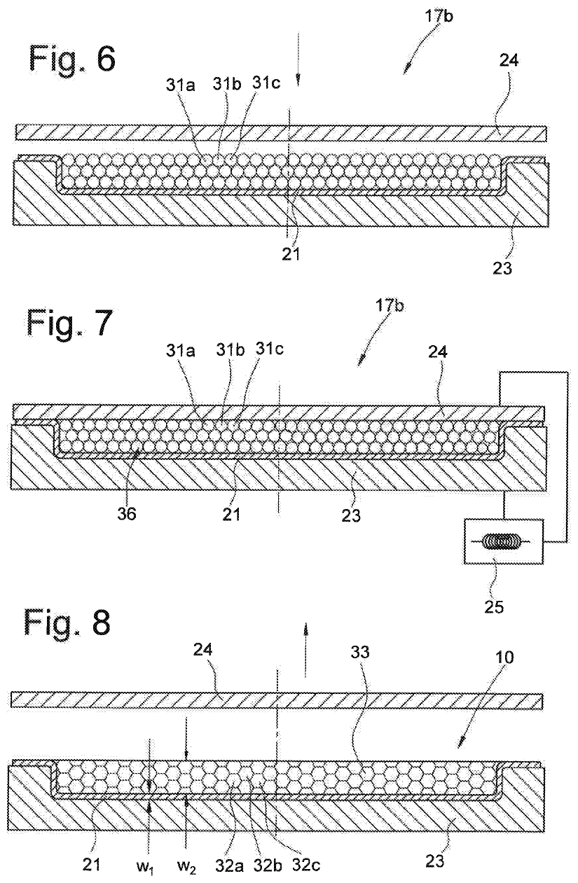

FIG. 6 shows the mold in FIG. 5 with additionally depicted upper mold part shortly before complete closure of the mold,

FIG. 7 shows the mold in FIG. 6 in a completely closed state, wherein a heating device for the mold is additionally depicted,

FIG. 8 shows the mold in FIG. 7 in the open state with baked and cured particle foam mass,

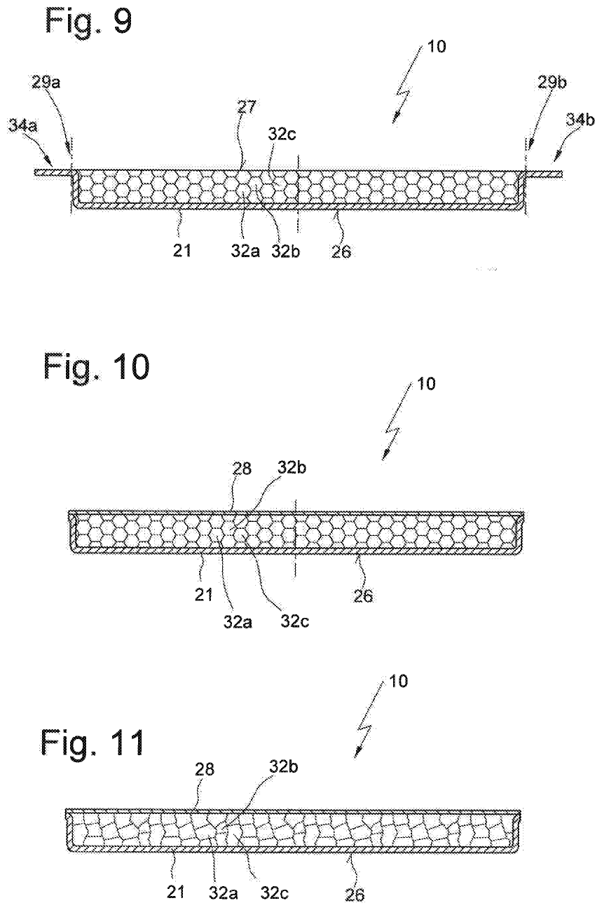

FIG. 9 shows the molded body removed from the mold in FIG. 8 with an indication of separation lines, along which protruding regions of the substrate are separated,

FIG. 10 shows another embodiment of a molded body or a component according to the invention formed according to the inventive method with an additional layer on the face of the cured particle foam mass directed away from the substrate,

FIG. 11 shows another embodiment of a component according to the invention in a depiction according to FIG. 10, wherein the pore structure of the cured particle foam is depicted purely for illustrative purposes in a modified manner compared with FIG. 10,

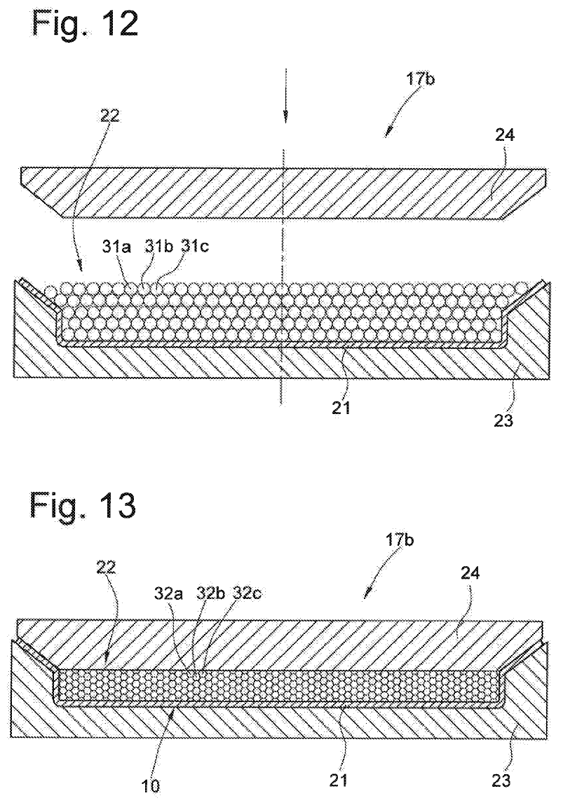

FIG. 12 shows another embodiment to illustrate the method according to the invention in a depiction according to FIG. 5, wherein a mold is depicted in an open state, into which completely expanded, loose particles have been filled, wherein the volume of the particles poured into the mold is greater than the volume of the cavity in the mold, and

FIG. 13 shows, in a depiction according to FIG. 12, the closed mold with compression of the loose, granular expanded particles in FIG. 12 to illustrate a volume reduction achieved in the mold accompanied by the already performed step of baking.

embodiments of the invention are described by way of example in the following description of the figures, also with reference to the drawings. For the sake of clarity here—even so far as different embodiments are concerned—identical or comparable parts or elements or regions are designated by the same reference characters, in some cases with the addition of small letters.

Features that are described, depicted or disclosed only in relation to one embodiment can be provided in the scope of the invention also in any other embodiment of the invention. embodiments modified in such a way are also comprised by the invention, even if they are not depicted in the drawings.

All disclosed features are themselves essential to the invention. The disclosure content of the associated priority documents (copy of the earlier application) and the cited printed publications and the described devices of the prior art are hereby also fully included in the disclosure of the application, also for the purpose of including individual or multiple features of the subject matters disclosed there in one or more claims of the present application. Such modified embodiments are also comprised by the invention, even if they are not depicted in the drawings.

embodiments of components that have been made according to the method according to the invention are designated in their totality by 10 in FIGS. 8, 9, 10, 11 and 13.

The method of making such a component 10 is to be presented below starting out from FIG. 1:

According to FIG. 1, a container 12 is depicted into which a granulate 11 of a particle foam is filled. The individual granulate particles, which are designated by the reference characters 30a, 30b, 30c as an example, are unexpanded and represent the starting material of making a particle foam. The individual materials that can be used according to the inventive method will be considered in detail elsewhere.

According to FIG. 2, the container 12 is part of an oven 13, in which the granulate particles 30a, 30b, 30c can be completely expanded:

To this end a heater 14, in particular an infrared heater 14, is provided, which by the use of infrared rays 15 (indicated) introduces a predetermined radiation output into the oven 13, in order to achieve a certain temperature or a certain temperature range. The granulate particles 30a, 30b, 30c are exposed in the oven 13 to the influence of temperature for a predetermined time, and foam completely. It is recognized that the individual particles 30a, 30b, 30c of FIG. 1 gain considerably in volume and mutate according to FIG. 2 into completely expanded particles 31a, 31b, 31c.

Let it be noted that the figures should naturally not be understood as being to scale, only that the process of expanding and the volume increases are to be depicted by way of example.

The completely expanded particles 31a, 31b, 31c are still loose, in particular not joined to one another. During the process of expanding according to FIG. 2, it can be achieved by additional measures, such as shaking the container 12, for example, stirring, the use of chemicals, or introduction of chemicals into the container 12 etc. that the particles 31a, 31b, 31c do not connect to one another or do not mainly connect to one another but are still transportable as a loose, free-flowing or pourable mass. This mass is filled according to FIG. 5 into a lower mold part 23 of a mold 17b.

The production of the substrate 21 is to be explained first by means of FIGS. 3 to 4:

According to FIG. 3, a first mold 17 is provided that comprises an upper mold part 18 and a lower mold part 19. The relevant mold parts can be designed as a female mold and a male mold. A film 20 in a flat, web-like state is recognized in FIG. 3, thus in a starting state. FIG. 3 shows the mold in an open state.

As a result of closing the mold, the film 20 is thermoformed from the flat state. Any spatial contour can be applied to the film by the thermoforming process. The thermoforming process can be supported by temperature in a conventional manner that is not depicted in the figures. Alternatively to the stamping/swaging process of the mold 17 in FIG. 3, blow-molding processes or other forming processes, in which the film is heated and brought into its final form by suction, can be considered for the thermoforming process.

Following the opening of the mold 17 from the state in FIG. 4, the thermoformed film 21 can be removed and supplied to another mold. Such a second mold 17b is depicted in FIGS. 5 to 8.

It is also comprised by the invention when the film 21 remains in the lower mold part 19 following the thermoforming process, and only the upper mold part is exchanged. Let it be assumed below that starting out from FIG. 5, the thermoformed film 21 has been introduced into another, second lower mold part 23 of another mold 17b.

According to FIG. 5, the free-flowing or pourable mass of completely expanded particles 31a, 31b, 31c is introduced into the lower mold part 23 into a cavity 22 that is used to receive the completely expanded particles 31a, 31b, 31c and that faces the rear face 35 of the thermoformed film 21. The second lower mold part 23 and the cavity 22 provided for it can be filled manually or mechanically or aided by machine until a predetermined volume or a predetermined mass of completely expanded particles 31a, 31b, 31c is positioned and in particular also distributed in the cavity 22.

A delivery or outputting device, not shown in the figures, can be provided here that distributes the particles uniformly along the cavity 22 like a supply head.

The mold 17b is then closed. To this end an upper mold part 24 is moved starting out from a state according to FIG. 6, in which the mold 17b is still partly open, to a closed state. The cavity 22 is now closed on all sides.

FIG. 7 indicates a heater 25 that maintains a temperature of the mold 17b, preferably both of the lower mold part 23 and the upper mold part 24. The mold temperature is selected according to the materials used for the particle foam.

In consequence of the temperature influence and if applicable also in consequence of a pressure influence as a result of closing the mold, the completely expanded particles 31a, 31b, 31c are baked with one another and with the film 21. The baked particle foam mass is formed in particular homogeneously.

A honeycomb structure is recognizable, only indicated by way of example in FIG. 8. This should likewise only be understood schematically, and is intended to indicate the dimensional stability and the homogeneity: in fact, the structure of the baked particle foam will be formed irregularly. Another comparable structure is shown—likewise purely schematically—by FIG. 11:

Here instead of the framework structure of FIG. 8 there is shown an irregular, approximately polygon-like structure in the schematic sectional representation.

FIG. 8 makes it clear that the completely expanded particles 31a, 31b, 31c according to FIG. 7 are baked to a continuous particle foam mass of a substantially homogeneous nature, wherein no or substantially no further free spaces remain between individual expanded particles 31a, 31b, 31c. FIG. 7, on the other hand, still indicates such free spaces, designated 36 by way of example.

Let it be noted that even if the overall volume of the expanded particles 31a, 31b, 31c is reduced on baking, or is not or not substantially changed, the contours of the individual particles 31a, 31b, 31c may very well be subjected to changes.

Following the baking of the particles 31a, 31b, 31c with one another, the baked particles are designated by the reference characters 32a, 32b, 32c by way of example in the embodiments of FIGS. 8, 9, 10, 11 and 13.

The plurality of the particles 32a, 32b, 32c baked with one another in fact forms a homogeneous particle foam mass 33 overall or a homogeneously expanded particle foam. This can also cure within a short time according to FIG. 8, in particular by cooling of the mold to a temperature below the melting temperature of the particle foam mass, so that—as indicated in FIG. 8—the mold can be opened and the upper mold part 24 can be raised from the lower mold part 23. Now the molded body 10 thus formed can be removed from the mold form.

As a result of the process of baking—in a closed mold—the particle foam bonds durably and firmly to the inside 35 of the molded film 21. A light, bend-proof and load-bearing and yet inexpensively producible composite is provided by this.

According to FIG. 9, projection regions 34a, 34b of the film 21 can be detached if necessary along the separation lines 29a, 29b.

The embodiment of FIG. 10 shows the rear face 27 of the component 10 that can be provided with an additional layer 28, e.g. of plastic.

Comprised by the invention are also components in which, instead of a thermoformed film 21 of ABS or PMMA, a thin film of polyethylene or polypropylene, or in particular also so-called slush skins are used as a substrate.

The face 26 of the thermoformed film 21 directed away from the cured particle foam mass 33 can form a high-quality surface. Since conventional known and proven materials can be reverted to for the provision of a thermoformed film 21, pertinent surface properties corresponding to those of conventional materials can be achieved.

It is also comprised by the invention when the surface 26 of the substrate 21 is subjected to separate processing in order to provide a high-quality surface. Thus processing steps such as polishing, lacquering, steaming, roughening, wetting etc. can be considered.

In FIG. 8 the wall thicknesses W1 of the thermoformed film 21 or of the substrate and W2, namely the wall thickness of the cured particle foam mass 33, are indicated as an example. The wall thickness W1 can be between 0.2 mm and 13 mm, and the wall thickness W2 between 1 cm and 30 cm.

Comprised in particular by the invention are components that are designed as caravan wall elements. For example, wall sections of a caravan trailer or a caravan, or complete wall elements of a caravan, can be used in automotive construction with the use of the method according to the invention.

Further comprised by the invention are embodiments that provide that, before filling of the cavity 22 with completely expanded particles 31a, 31b, 31c, reinforcing elements are placed in the cavity 22.

The reinforcing elements, which are not depicted in the figures, can have e.g. reinforcing fibers. As a result of filling the cavity 22 with completely expanded particles 31a, 31b, 31c, the particles are evenly distributed and encase the reinforcing elements on multiple sides, preferably on all sides. The finished component 10 comprises a cured particle foam mass that securely encloses the reinforcing elements. Due to the positioning of the reinforcing elements, tensile forces in particular can be transmitted and intercepted.

According to the embodiment in FIG. 12, it is clear that the interior 22 of the mold 17b can have a certain volume. The volume of the expanded particles 31a, 31b, 31c that are introduced into the mold can be greater in the implementation variant in FIGS. 12 and 13, on the other hand. The volume of the particles 31a, 31b, 31c is therefore greater in total than the volume of the cavity 22.

As a result of closing the mold 17b, thus by completion of a movement towards one another by the upper mold part 24 relative to the lower mold part 23, the loose granular particle foam mass of the expanded particles 31a, 31b, 31c can be compressed, and then the step of baking can be carried out under pressure. A reduction can be achieved here in the volume of the particle foam mass.

Following the volume reduction, thus after carrying out the step of baking and following curing, the volume of the particle foam mass naturally corresponds to the volume of the interior 22 of the mold.

FIG. 13 shows the particle foam mass in the baked and cured state, therefore shortly before opening of the mold for the purpose of removing the molded body 10 formed in this way.

In the embodiment in FIGS. 12 and 13 the mold is overcharged in this respect with expanded particles 31a, 31b, 31c. The degree of overcharging can be between 100% and 150%, for example, advantageously between 105% and 115%, relative to the volume of the interior 22 of the mold 17b.

1. A method of making a thin component in lightweight sandwich construction with a high-quality surface, the method comprising the following steps of:
a) providing a film like substrate;
b) introducing the substrate into a lower mold part of a mold;
c) providing a granular starting material in the form of loose particles of an expandable particle foam;
d) completely expanding the particles;
h) baking the expanded particles into a curable particle foam that bonds to the substrate; and
i) curing the particle foam to form a molded body with the substrate.

2. The method according to claim 1, wherein the substrate is a thermoformed film.

3. The method according to claim 1, further comprising the step of:
k) applying a cover layer to a face of the particle foam directed away from the substrate.

4. The method according to claim 1, further comprising the step of:
g) processing of the molded body into a component.

5. The method according to claim 2, wherein the film has a wall thickness of between 0.2 mm and 13 mm.

6. The method according to claim 1, wherein the cured particle foam of step i) has a wall thickness of between 1 cm and 30 cm.

7. The method according to claim 1, further comprising the step of:
g) the mold forming the component into a vehicle part for a motor vehicle or for a commercial vehicle or for a trailer.

8. The method according to claim 1, wherein the starting material is expandable EPS, PP or PEEK.

9. The method according to claim 1, further comprising, before step h), the step of:
m) positioning of reinforcing elements in the lower mold part such that introduction of the expanded particles into the lower mold part encases the reinforcing elements with the expanded particles.

10. A flat component with a high-quality surface made according to claim 1, the component comprising a substrate to which the cured particle foam is bonded.

11. The component according to claim 10, wherein the film has a wall thickness of between 0.2 mm and 13 mm.

12. The component according to claim 10, wherein the cured particle foam has a wall thickness of between 1 cm and 30 cm.

13. The component according to claim 10, wherein the particle foam is expanded against the substrate.

14. The method according to claim 1, wherein in step b) the substrate is introduced into a cavity of the lower mold part, the method further comprising between steps d) and e) the steps of sequentially:
e) introducing the completely expanded particles into the cavity of the lower mold part on top of the substrate,
f) closing the mold,
g) heating the mold.

15. The method according to claim 1, wherein steps d), h) and i) are carried out in a cavity of the lower mold part.

16. The method according to claim 7, wherein the vehicle part is interior design part, cargo space cover, lining part, engine bonnet, roof element or roof segment, vehicle wall, or vehicle wall element.

17. The method according to claim 1, further comprising the step after step i) of:
j) opening the mold and removing the molded body therefrom.
